(19) United States
(12) Patent Application Publication
(10) Pub. No.: US 2015/0036875 A1
(43) Pub. Date: Feb. 5, 2015

(54) METHOD AND SYSTEM FOR APPLICATION EXECUTION BASED ON OBJECT RECOGNITION FOR MOBILE DEVICES

(71) Applicant: NVIDIA Corporation, Santa Clara, CA (US)

(72) Inventor: Guillermo SAVRANSKY, Mountain View, CA (US)

(73) Assignee: NVIDIA Corporation, Santa Clara, CA (US)

(21) Appl. No.: 13/955,456

(22) Filed: Jul. 31, 2013

(51) Int. Cl. G06K 9/00; G06K 9/66; G06T 7/00

(52) U.S. Cl. CPC G06K 9/00771; G06T 7/0042; G06T 7/0044; G06K 9/66
USPC 382/103

(57) ABSTRACT

Embodiments of the present invention enable mobile devices to behave as a dedicate remote control for different target devices through camera detection of a particular target device and autonomous execution of applications linked to the detected target device. Also, when identical target devices are detected, embodiments of the present invention may be configured to use visual identifiers and/or positional data associated with the target device for purposes of distinguishing the target device of interest. Additionally, embodiments of the present invention are capable of being placed in a surveillance mode in which camera detection procedures are constantly performed to locate target devices. Embodiments of the present invention may also enable users to engage this surveillance mode by pressing a button located on the mobile device. Furthermore, embodiments of the present invention may be trained to recognize target devices.

### FIELD OF THE INVENTION

Embodiments of the present invention are generally related to the field of devices capable of image capture.

### BACKGROUND OF THE INVENTION

Conventional mobile devices, such as smartphones, include the technology to perform a number of different functions. For example, a popular function available on most conventional mobile devices is the ability to use the device to control other electronic devices from a remote location. However, prior to enabling this functionality, most conventional mobile devices require users to perform a number of preliminary steps, such as unlocking the device, supplying a password, searching for the application capable of remotely controlling the target device, etc.

As such, conventional mobile devices require users to “explain” what function they wish to perform with the electronic device they wish to control. Using these conventional devices may prove to be especially cumbersome for users who wish to use their mobile devices to control a number of electronic devices, which may require users to execute a number of different applications. Accordingly, users may become weary of having to perform preliminary steps for each application and frustrated at not being able to efficiently utilize the remote control features of their mobile device.

### SUMMARY OF THE INVENTION

Accordingly, a need exists for a solution that enables users to control remote electronic devices (“target devices”) using their mobile devices in a more efficient manner. Embodiments of the present invention enable mobile devices to behave as a dedicated remote controls for different target devices through camera detection of recognized target devices and autonomous execution of applications linked to those devices. Also, when identical target devices are detected, embodiments of the present invention may be configured to use visual identifiers and/or positional data associated with the target device for purposes of distinguishing the target device of interest. Additionally, embodiments of the present invention are capable of being placed in a surveillance mode in which camera detection procedures are constantly performed to locate target devices. Embodiments of the present invention may also enable users to engage this surveillance mode by pressing a button located on the mobile device. Furthermore, embodiments of the present invention may be trained to recognize target devices.

More specifically, in one embodiment, the present invention is implemented as a method of executing an application using a computing device. The method includes associating a first application with a first object located external to the computing device. Additionally, the method includes detecting the first object within a proximal distance of the computing device using a camera system. In one embodiment, the associating further includes training the computing device to recognize the first object using the camera system. In one embodiment, the detecting further includes detecting the first object using a set of coordinates associated with the first object. In one embodiment, the detecting further includes detecting the first object using signals emitted from the first object. In one embodiment, the detecting further includes configuring the computing device to detect the first object during a surveillance mode, in which the surveillance mode is engaged by a user using a button located on the computing device.

Furthermore, the method includes automatically executing the first application upon detection of the first object, in which the first application is configured to execute upon determining a valid association between the first object and the first application and detection of the first object. In one embodiment, the valid association is a mapped relationship between the first application and the first object, in which the mapped relationship is stored in a data structure resident on the computing device.

In one embodiment, the method further includes associating a second application with a second object located external to the computing device. In one embodiment, the method includes detecting the second object within a proximal distance of the computing device using a camera system. In one embodiment, the method includes automatically executing the second application upon detection of the second object, in which the second application is configured to execute upon determining a valid association between the second object and the second application and detection of the second object.

In one embodiment, the present invention is implemented as a system for executing an application using a computing device. The system includes an association module operable to associate the application with an object located external to the computing device. In one embodiment, the associating module is further operable to configure the computing device to recognize the object using machine learning procedures.

Also, the system includes a detection module operable to detect the object within a proximal distance of the computing device using a camera system. In one embodiment, the associating module is further operable to train the computing device to recognize the object using the camera system. In one embodiment, the detection module is further operable to detect the object using a set of coordinates associated with the object. In one embodiment, the detection module is further operable to detect the object using signals emitted from the object. In one embodiment, the detection module is further operable to detect the object during a surveillance mode, in which the surveillance mode is engaged by a user using a button located on the computing device.

Furthermore, the system includes an execution module operable to execute the application upon detection of the object, in which the execution module is operable to determine a valid association between the object and the application, in which the application is configured to automatically execute responsive to the valid association and said detection. In one embodiment, the valid association is a mapped relationship between the application and the object, in which the mapped relationship is stored in a data structure resident on the computing device.

In one embodiment, the present invention is implemented as a method of executing a computer-implemented system process using a computing device. The method includes associating the computer-implemented system process with an object located external to the computing device. In one embodiment, the associating further includes configuring the computing device to recognize visual identifiers located on the object responsive to a detection of similar looking objects.

The method also includes detecting the object within a proximal distance of the computing device using a camera system. In one embodiment, the associating further includes training the computing device to recognize the object using the camera system. In one embodiment, the detecting process further includes detecting the object using a set of coordinates associated with the object. In one embodiment, the detecting further includes detecting the object using signals emitted from the object. In one embodiment, the detecting further includes configuring the computing device to detect the object during a surveillance mode, in which the surveillance mode is engaged by a user using a button located on the computing device.

Furthermore, the method includes automatically executing the computer-implemented system process upon detection of the object, in which the computer-implemented system process is configured to execute upon determining a valid association between the object and the computer-implemented system process and detection of the object. In one embodiment, the valid association is a mapped relationship between the computer-implemented system process and the object, in which the mapped relationship is stored in a data structure resident on the computing device.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 depicts an exemplary system in accordance with embodiments of the present invention.

FIG. 2A depicts an exemplary object detection process using a camera system in accordance with embodiments of the present invention.

FIG. 2B depicts an exemplary triggering object recognition process in accordance with embodiments of the present invention.

FIG. 2C depicts an exemplary data structure capable of storing mapping data associated with triggering objects and their respective applications in accordance with embodiments of the present invention.

FIG. 2D depicts an exemplary use case of an application executed responsive to a detection of a triggering object in accordance with embodiments of the present invention.

FIG. 2E depicts an exemplary triggering object recognition process in which non-electronic devices are recognized in accordance with embodiments of the present invention.

FIG. 3A depicts an exemplary data structure capable of storing coordinate data associated with triggering objects, along with their respective application mappings, in accordance with embodiments of the present invention.

FIG. 3B depicts an exemplary triggering object recognition process using spatial systems in accordance with embodiments of the present invention.

FIG. 3C depicts an exemplary triggering object recognition process using signals emitted from a triggering object in accordance with embodiments of the present invention.

FIG. 4 is a flow chart depicting an exemplary application execution process based on the detection of a recognized triggering object in accordance with embodiments of the present invention.

FIG. 5 is another flow chart depicting an exemplary application execution process based on the detection of multiple recognized triggering objects in accordance with embodiments of the present invention.

FIG. 6 is another flow chart depicting an exemplary application execution process based on the detection of a recognized triggering object using the GPS module and/or the orientation module in accordance with embodiments of the present invention.

FIG. 7 is yet another flow chart depicting an exemplary system process (e.g., operating system process) executed based on the detection of a recognized triggering object in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

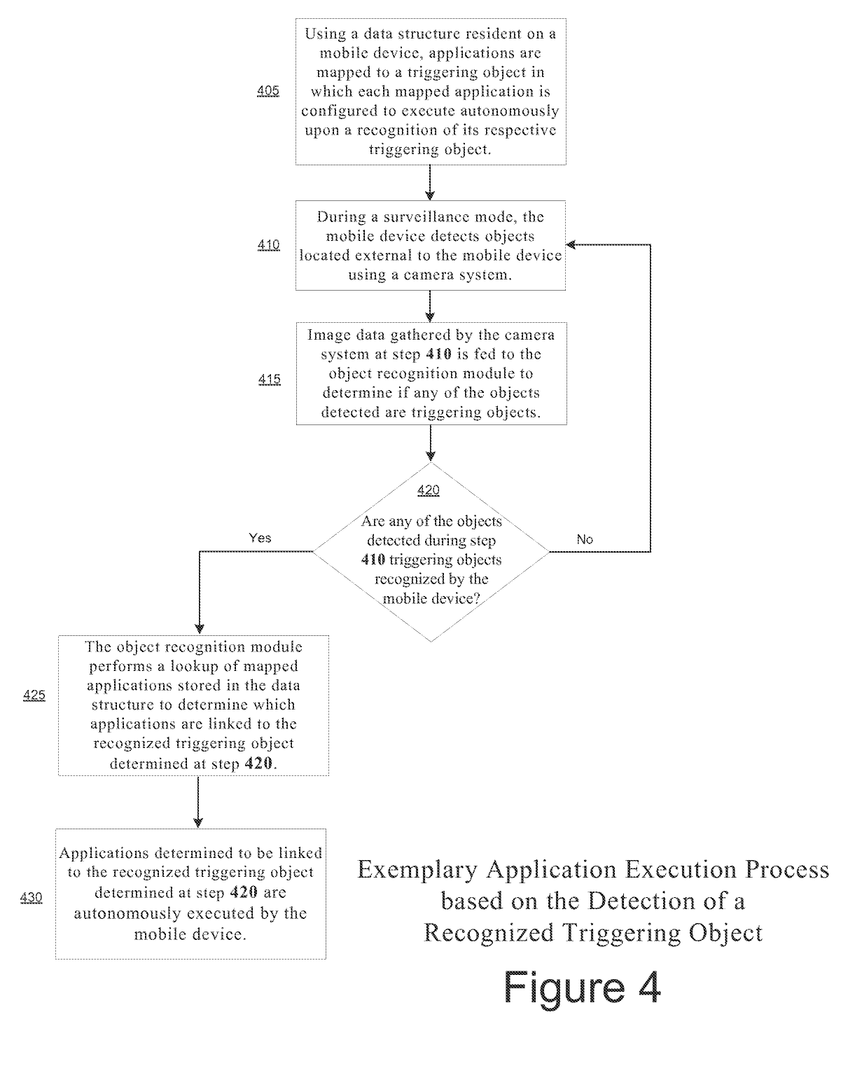

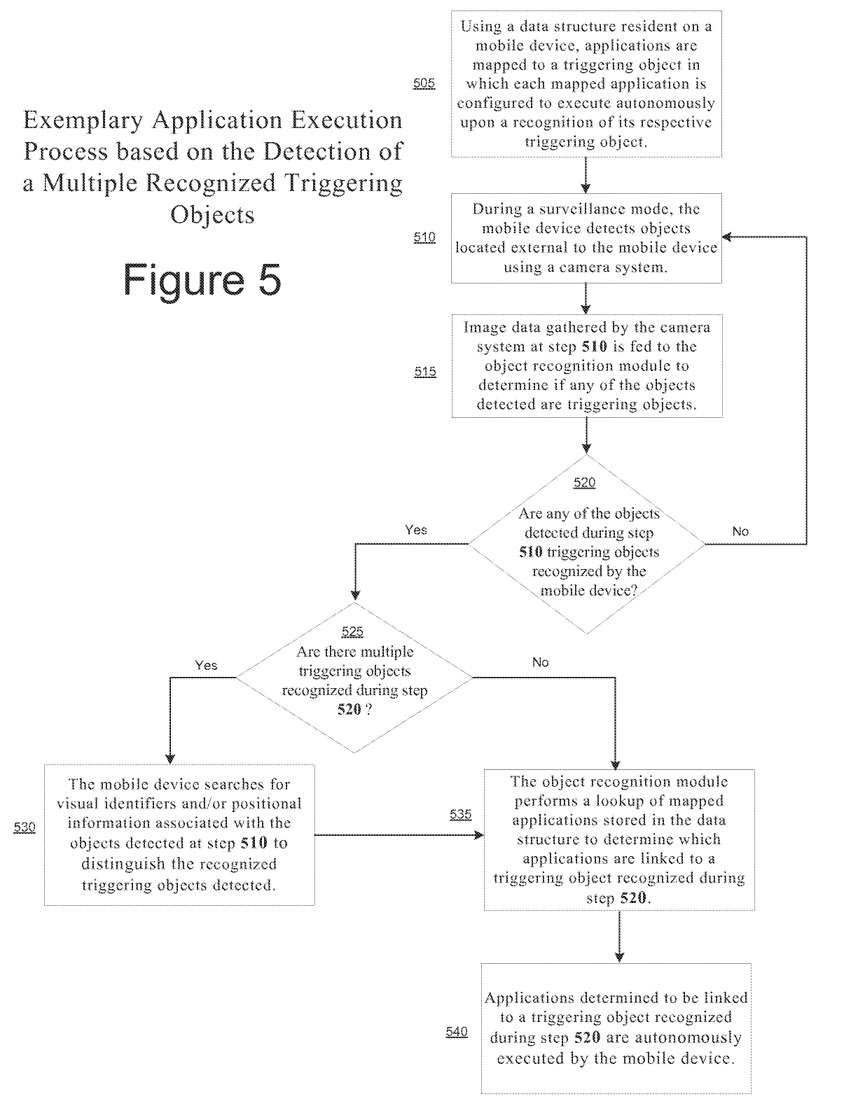

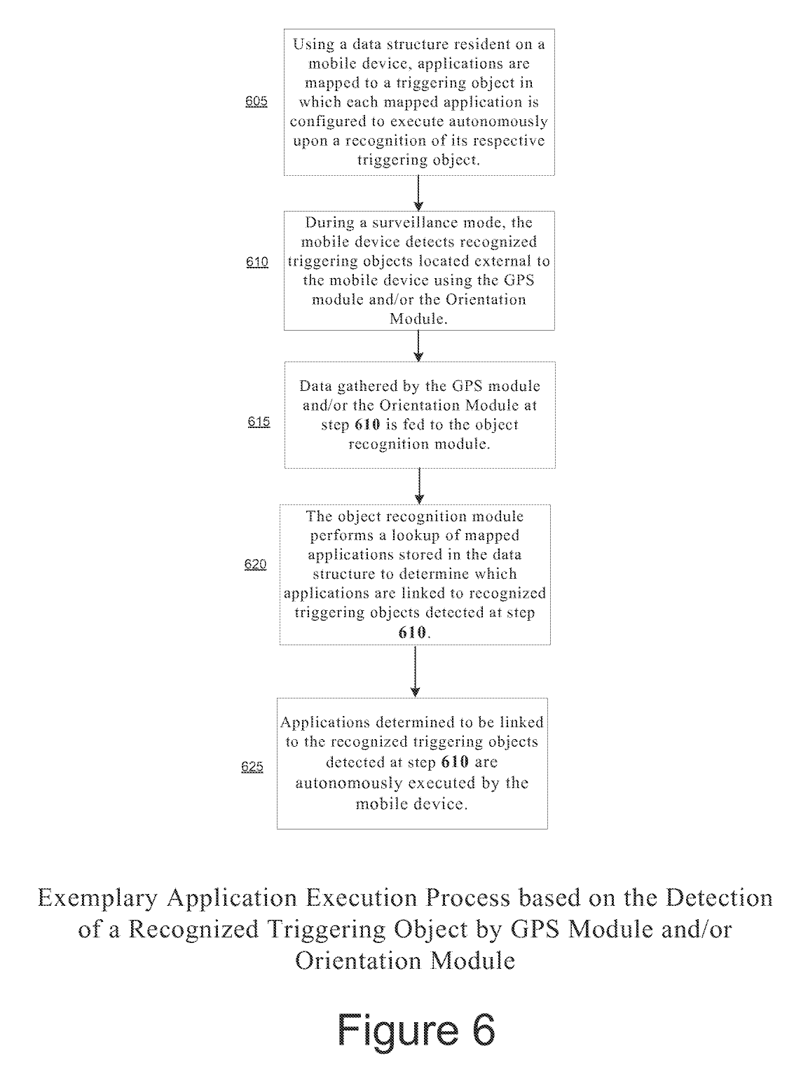

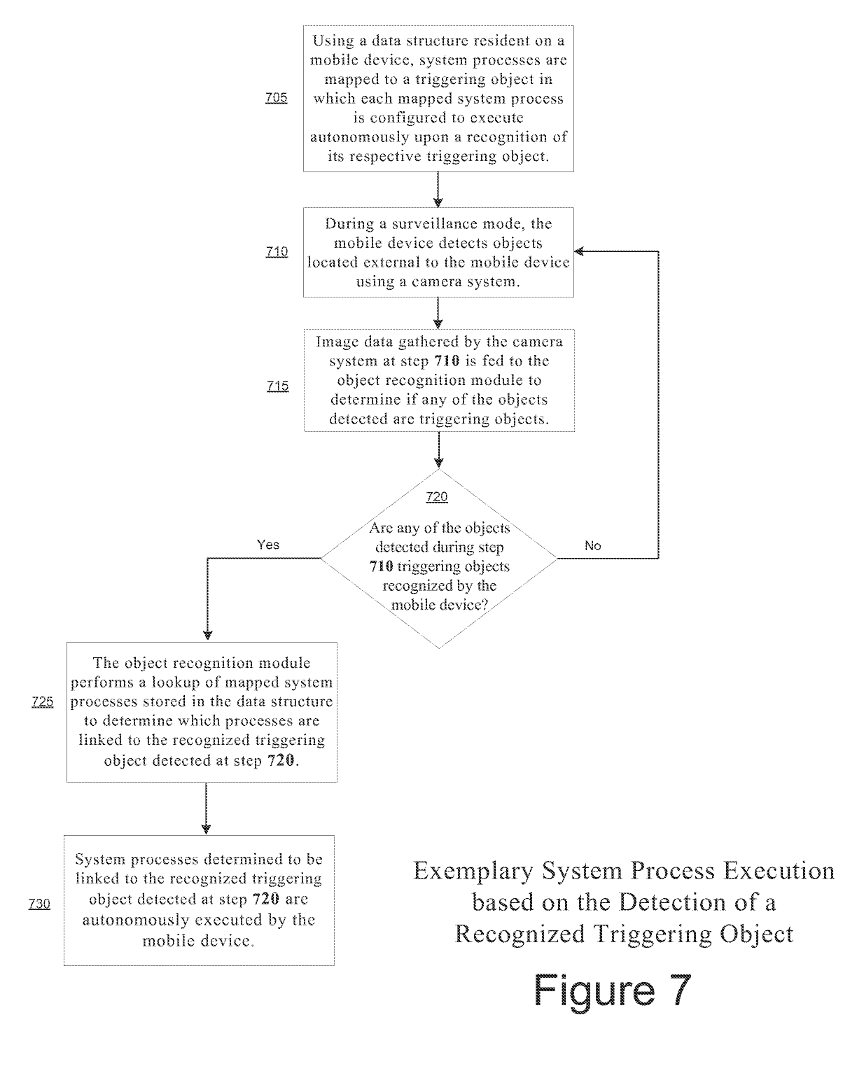

Portions of the detailed description that follow are presented and discussed in terms of a process. Although operations and sequencing thereof are disclosed in a figure herein (e.g., FIG. 4, FIG. 5, FIG. 6, FIG. 7) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, an object, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

### Exemplary System in Accordance with Embodiments of the Present Invention

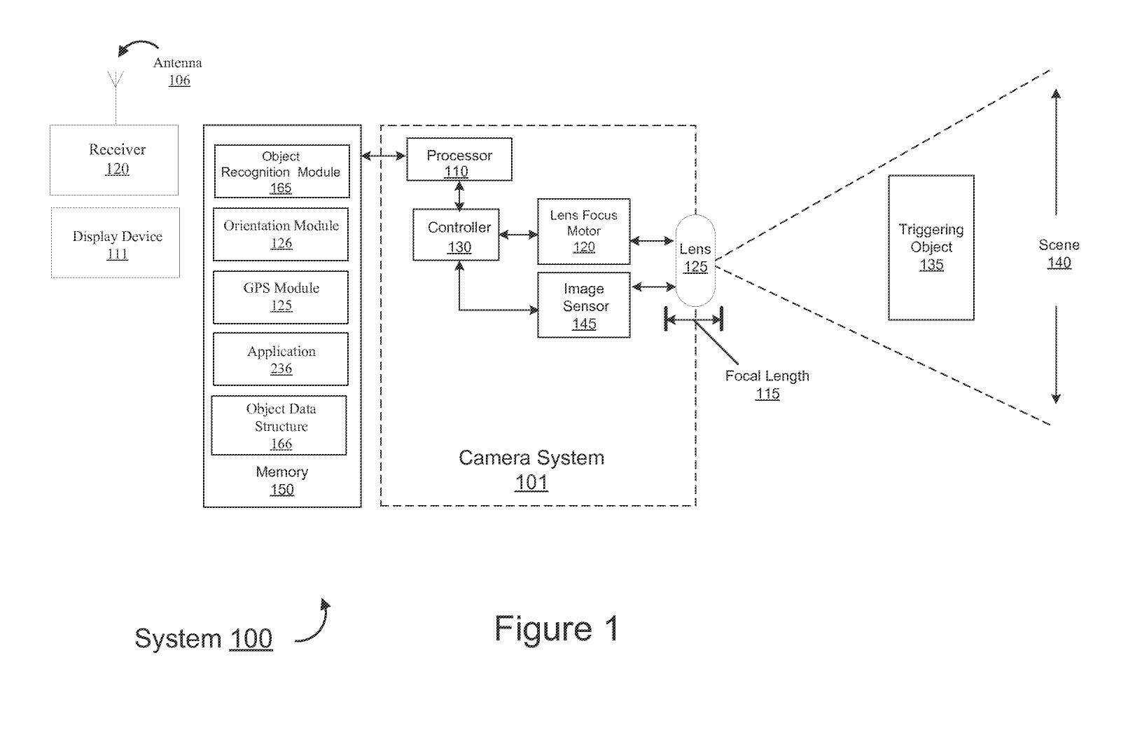

As presented in FIG. 1, an exemplary system 100 upon which embodiments of the present invention may be implemented is depicted. System 100 can be implemented as, for example, a digital camera, cell phone camera, portable electronic device (e.g., entertainment device, handheld device, etc.), webcam, video device (e.g., camcorder) and the like. Components of system 100 may comprise respective functionality to determine and configure respective optical properties and settings including, but not limited to, focus, exposure, color or white balance, and areas of interest (e.g., via a focus motor, aperture control, etc.). Furthermore, components of system 100 may be coupled via internal communications bus and may receive/transmit image data for further processing over such communications bus.

Embodiments of the present invention may be capable recognizing triggering objects within a proximal distance of system 100 that trigger the execution of a system process and/or application resident on system 100. Triggering objects (e.g., triggering object 135) may be objects located external to system 100. In one embodiment, triggering objects may be electronic devices capable of sending and/or receiving commands from system 100 which may include, but are not limited to, entertainment devices (e.g., televisions, DVD players, set-top boxes, etc.), common household devices (e.g., kitchen appliances, thermostats, garage door openers, etc.), automobiles (e.g., car ignition/door opening devices, etc.) and the like. In one embodiment, triggering objects may also be objects (e.g., non-electronic devices) captured from scenes external to system 100 using a camera system (e.g., image capture of the sky, plants, animals, etc.).

Additionally, applications residing on system 100 may be configured to execute autonomously upon recognition of a triggering object by system 100. For example, with reference to the embodiment depicted in FIG. 1, application 236 may be configured by the user to initialize or perform a function upon recognition of triggering object 135 by system 100. As such, the user may capable of executing application 236 by focusing system 100 in a direction relative to triggering object 135. In one embodiment, the user may be prompted by system 100 to confirm execution of application 236. Also, in one embodiment, one triggering object may be linked to multiple applications. As such, the user may be prompted to select which application to execute by system 100. Furthermore, users may be capable of linking applications to triggering objects through calibration or setup procedures using system 100.

According to one embodiment of the present invention, system 100 may be capable of detecting triggering objects using a camera system (e.g., camera system 101). As illustrated by the embodiment depicted in FIG. 1, system 100 may capture scenes (e.g., scene 140) through lens 125, which may be coupled to image sensor 145. According to one embodiment, image sensor 145 may comprise an array of pixel sensors operable to gather image data from scenes external to system 100 using lens 125. Image sensor 145 may include the functionality to capture and convert light received via lens 125 into a signal (e.g., digital or analog). Additionally, lens 125 may be placed in various positions along lens focal length 115. In this manner, system 100 may be capable of adjusting the angle of view of lens 125, which may impact the level of scene magnification for a given photographic position. In one embodiment, image sensor 145 may use lens 125 to capture images at high speed (e.g., 20 fps, 24 fps, 30 fps, or higher). Images captured may be operable for use as preview images and full resolution capture images or video. Furthermore, image data gathered from these scenes may be stored within memory 150 for further processing by image processor 110 and/or other components of system 100.

Although system 100 depicts only lens 125 in the FIG. 1 illustration, embodiments of the present invention may support multiple lens configurations and/or multiple cameras (e.g., stereo cameras). According to one embodiment, system 100 may include the functionality to use well-known object detection procedures (e.g., edge detection, greyscale matching, etc.) to detect the presence of potential triggering objects within a given scene.

According to one embodiment, users may perform calibration or setup procedures using system 100 which associate (“link”) applications to a particular triggering object. For example, in one embodiment, users may perform calibration or setup procedures using camera system 101 to capture images for use as triggering objects. As such, according to one embodiment, image data associated with these triggering objects may be stored in object data structure 166. Furthermore, triggering objects captured during these calibration or setup procedures may then be subsequently linked or mapped to system process and/or an application resident on system 100. In one embodiment, a user may use a system tool or linking program residing on system 100 to link image data associated with a triggering object (e.g., triggering object 135) to a particular system process and/or application (e.g., application 236) residing in memory 150.

Furthermore, for identical or similar looking triggering objects, embodiments of the present invention may also be configured to recognize visual identifiers or markers to resolve which trigging object is of interest to an application. For example, visual identifiers may be unique identifiers associated with a particular triggering object. For instance, unique visual identifiers may include, but are not limited to, serial numbers, barcodes, logos, etc. In one embodiment, visual identifiers may not be unique. For instance, visual identifiers may be generic labels (e.g., stickers) affixed to a trigging object by the user for purposes of training system 100 to distinguish similar looking triggering objects. Furthermore, data used by system 100 to recognize visual identifiers may be predetermined using a priori data loaded in memory resident on system 101 in factory. In one embodiment, users may perform calibration or setup procedures using camera system 101 to identify visual identifiers or markers. According to one embodiment, the user may be prompted to resolve multiple triggering objects detected within a given scene. For instance, in one embodiment, system 100 may prompt the user via the display device 111 of system 100 (e.g., viewfinder of a camera device) to select a particular triggering object among a number of recognized triggering objects detected within a given scene. In one embodiment, the user may make selections using touch control options (e.g., “touch-to-focus”, “touch-to-record”) made available by the camera system.

According to one embodiment, system 100 may be configured to recognize triggering objects using machine-learning procedures. For example, in one embodiment, system 100 may gather data that correlates application execution patterns with objects detected by system 100 using camera system 101. Based on the data gathered, system 100 may learn to associate certain applications with certain objects and store the learned relationship in a data structure (e.g., object data structure 166).

Object data structure 166 may include the functionality to store data mapping the relationship between triggering objects and their respective applications. For example, in one embodiment, object data structure 166 may be a data structure capable of storing mapping data indicating the relationship between various differing triggering objects and their respective applications. Object recognition module 165 may include the functionality to receive and compare image data gathered by camera system 101 to image data associated with recognized triggering objects stored in object data structure 166.

For instance, according to one embodiment, image data stored in object data structure 166 may consist of pixel values (e.g., RGB values) associated with various triggering objects recognized (e.g., through training or calibration) by system 100. As such, object recognition module 165 may compare the pixel values of interesting objects detected using camera system 101 (e.g., from image data gathered via image sensor 145) to the pixel values of recognized triggering objects stored within object data structure 166. In one embodiment, if the pixel values of an interesting object are within a pixel value threshold of a recognized triggering object stored within object data structure 166, object recognition module 165 may make a determination that the interesting object detected is the recognized triggering object and then may proceed to perform a lookup of any applications linked to the recognized triggering object detected. It should be appreciated that embodiments of the present invention are not limited by the manner in which pixel values are selected and/or calculating for analysis by object recognition module 165 (e.g., averaging RGB values for selected groups of pixels).

Embodiments of the present invention may also be capable of detecting triggering objects based on information concerning the current relative position of system 100 with respect to the current location of a triggering object. With further reference to the embodiment depicted in FIG. 1, system 100 may be capable of detecting triggering objects using orientation module 126 and/or GPS module 125. Orientation module 126 may include the functionality to determine the orientation of system 100. According to one embodiment, orientation module 126 may use geomagnetic field sensors and/or accelerometers (not pictured) coupled to system 100 to determine the orientation of system 100. Additionally, GPS module 125 may include the functionality to gather coordinate data (e.g., latitude, longitude, elevation, etc.) associated with system 100 at a current position using conventional global positioning system technology. In one embodiment, GPS module 125 may be configured to use coordinates provided by a user that indicate the current location of the triggering object so that system 100 may gauge its position with respect to the triggering object.

According to one embodiment, object recognition module 165 may include the functionality to receive and compare coordinate data gathered by orientation module 126 and/or GPS module 125 to coordinate data associated with recognized triggering objects stored in object data structure 166. For instance, according to one embodiment, data stored in object data structure 166 may include 3 dimensional coordinate data (e.g., latitude, longitude, elevation) associated with various triggering objects recognized by system 100 (e.g., coordinate data provided by a user). As such, object recognition module 165 may compare coordinate data calculated by orientation module 126 and/or GPS module 125 providing the current relative position of system 100 to coordinate data associated with recognized triggering objects stored within object data structure 166. In one embodiment, if the values calculated by orientation module 126 and/or GPS module 125 place system 100 within a proximal distance threshold of a recognized triggering object stored within object data structure 166, object recognition module 165 may make a determination that system 100 is in proximity to that particular triggering object detected and then may proceed to perform a lookup of any applications linked to the triggering object detected. It should be appreciated that embodiments of the present invention are not limited by the manner in which orientation module 126 and/or GPS module 125 calculates the current relative position of system 100.

In one embodiment, users may perform calibration or setup procedures using orientation module 126 and/or GPS module 125 to determine locations for potential triggering objects. For instance, in one embodiment, a user may provide latitude, longitude, and/or elevation data concerning various triggering objects to system 100 for use in subsequent triggering object detection procedures. Furthermore, triggering objects locations determined during these calibration or setup procedures may then be subsequently mapped to an application resident on system 100 by a user.

According to one embodiment, system 100 may use data gathered from a camera system coupled to system 100 as well as any positional and/or orientation information associated with system 100 for purposes of accelerating the triggering object recognition process. For example, according to one embodiment, coordinate data associated with recognized triggering objects may be used in combination with camera system 101 to accelerate the recognition of triggering objects. As such, similar looking triggering objects located in different regions of a given area (e.g., similar looking televisions placed in different rooms of a house) may be distinguished by embodiments of the present invention in a more efficient manner.

### Exemplary Methods of Application Execution Based on Object Recognition in Accordance with Embodiments of the Present Invention

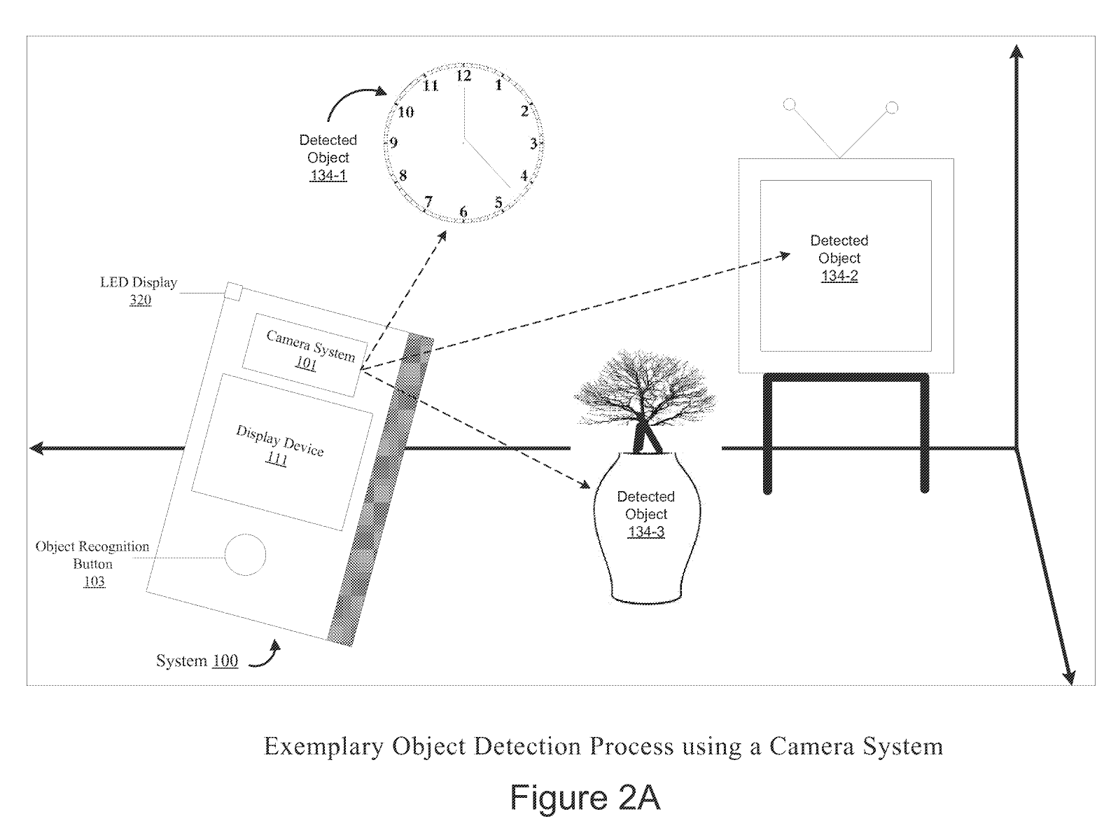

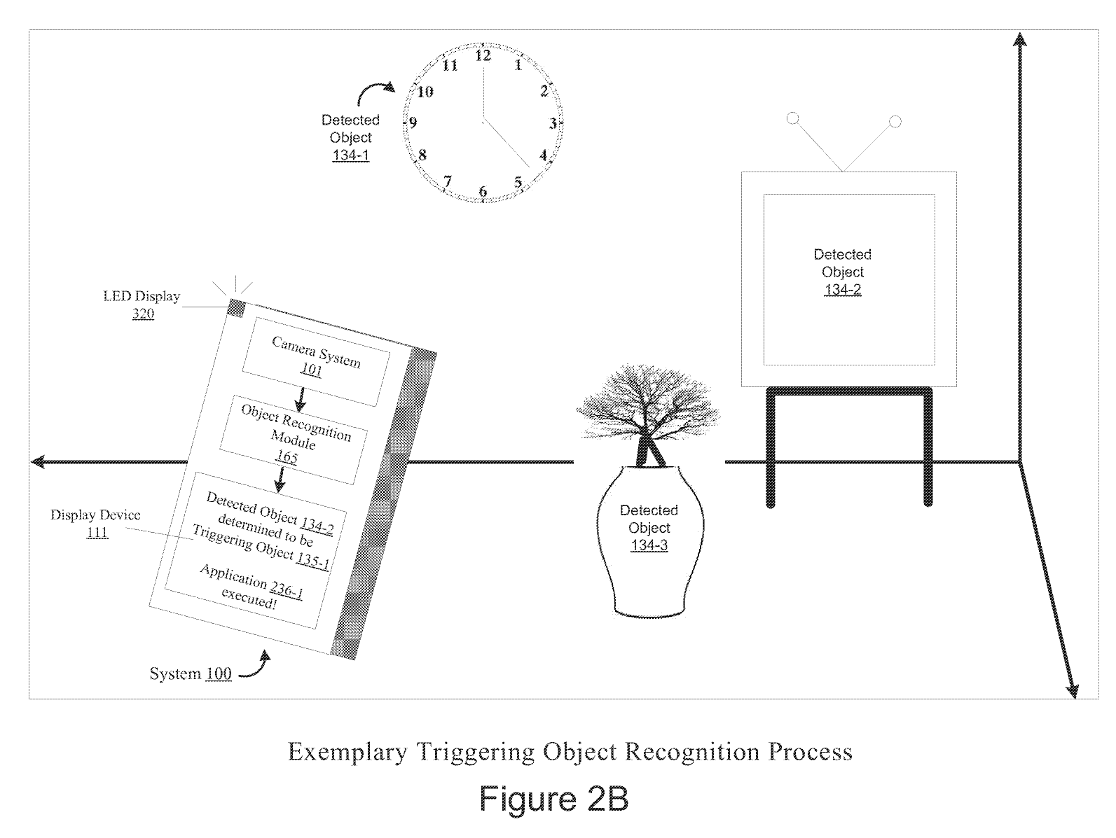

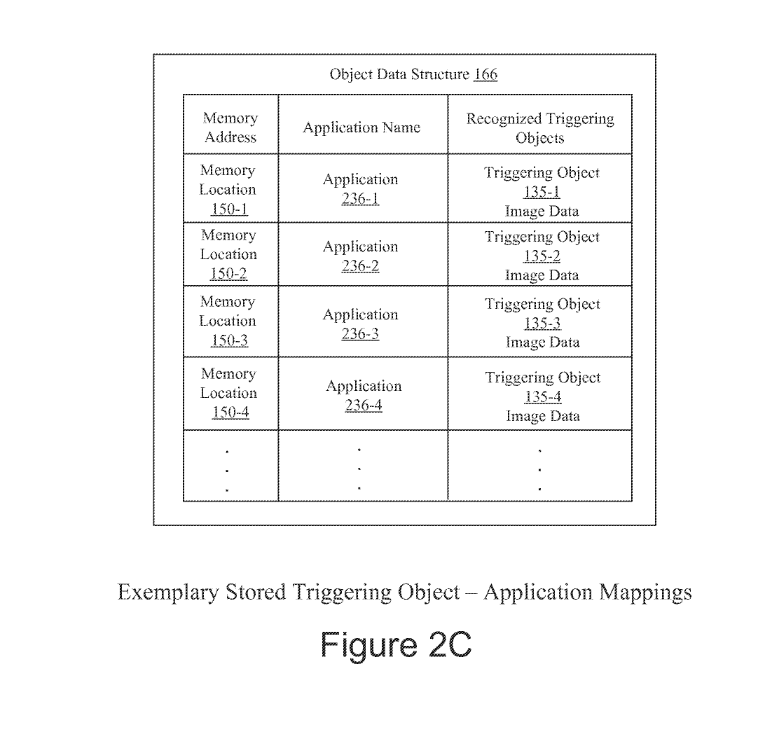

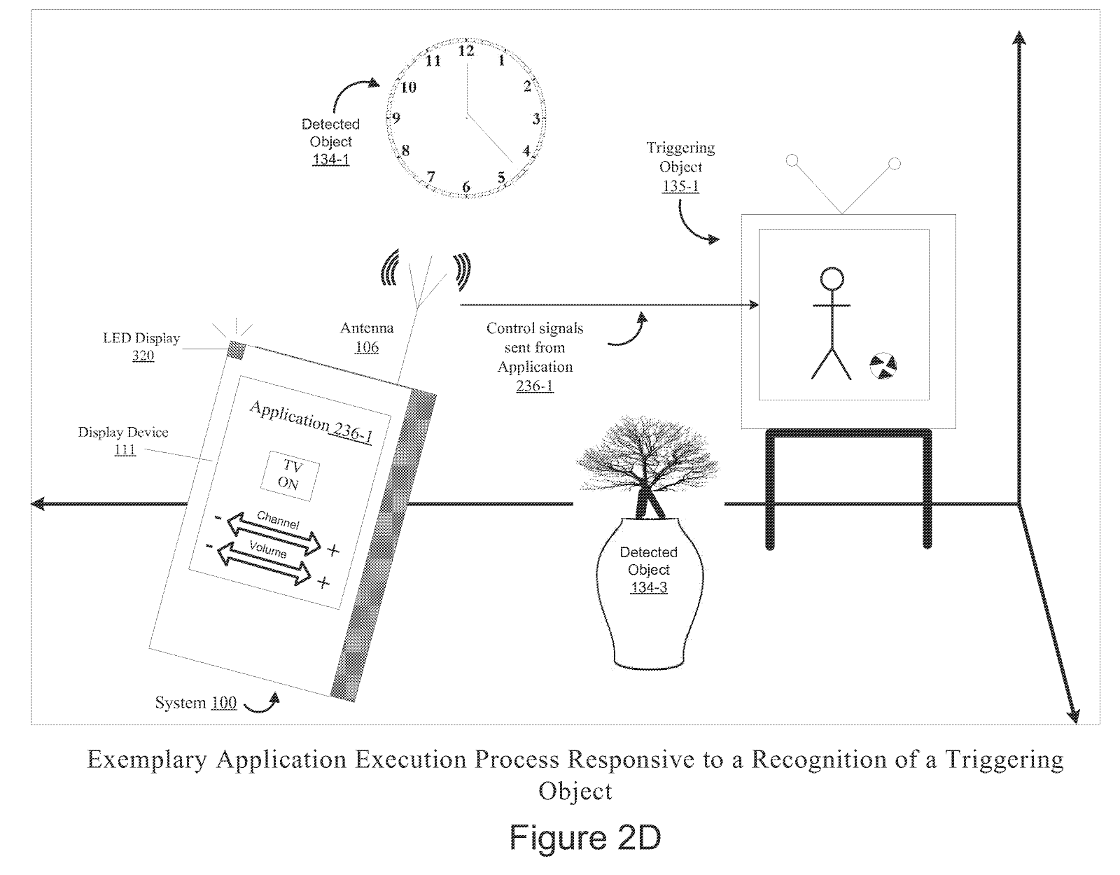

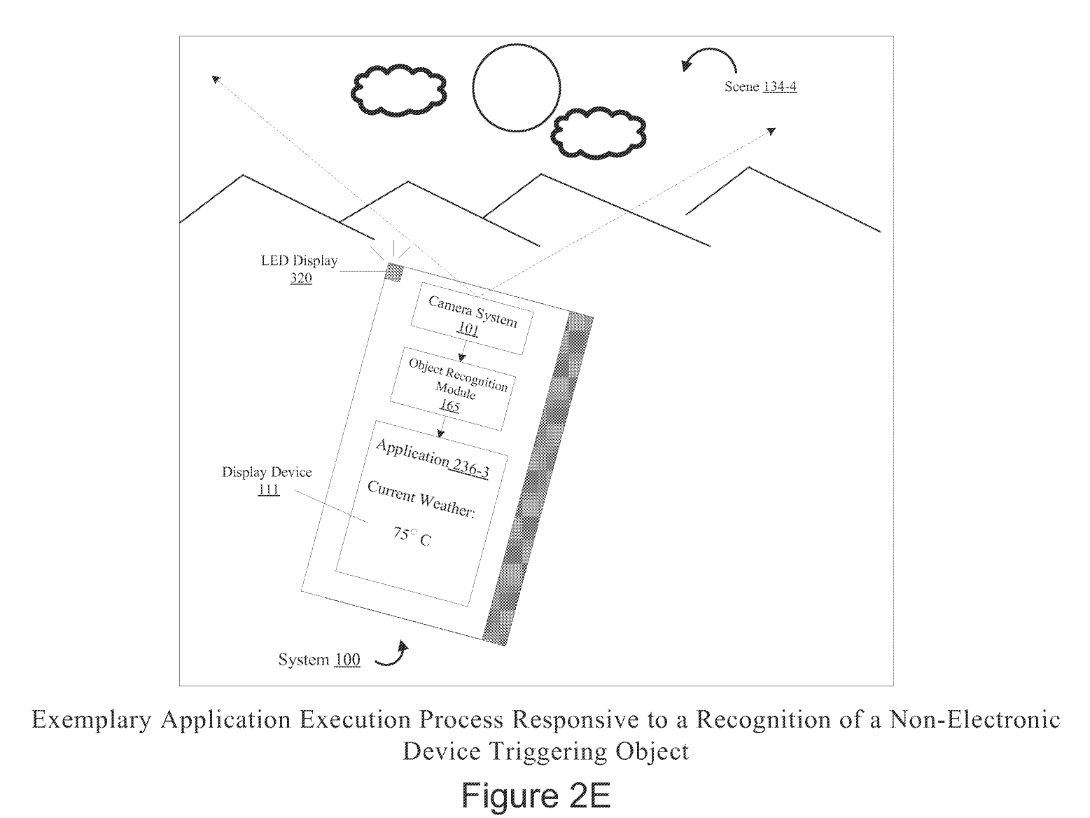

FIG. 2A depicts an exemplary triggering object detection process using a camera system in accordance with embodiments of the present invention. As described herein, system 100 may be capable of detecting potential triggering objects using a camera system (e.g., camera system 101). As illustrated in FIG. 2A, system 100 may be placed in a surveillance mode in which camera system 101 surveys scenes external to system 100 for potential triggering objects (e.g., detected objects 134-1, 134-2, 134-3). In one embodiment, system 100 may be engaged in this surveillance mode by pressing object recognition button 103. Object recognition button 103 may be implemented as various types of buttons including, but not limited to, capacitive touch buttons, mechanical buttons, virtual buttons, etc. In one embodiment, system 100 may be configured to operate in a mode in which system 100 is constantly surveying scenes external to system 100 for potential triggering objects and, thus, may not require user intervention for purposes of engaging system 100 in a surveillance mode.

FIG. 2B depicts an exemplary triggering object recognition process in accordance with embodiments of the present invention. As described herein, applications mapped in object data structure 166 may be configured to execute autonomously immediately upon recognition of their respective triggering objects by object recognition module 165. As illustrated in FIG. 2B, camera system 101 may also be capable of providing object recognition module 165 with image data associated with detected objects 134-1, 134-2, and/or 134-3 (e.g., captured via image sensor 145). As such, object recognition module 165 may be operable to compare the image data received from camera system 101 (e.g., image data associated with detected objects 134-1, 134-2, 134-3) to the image data values of recognized triggering objects stored in object data structure 166. As illustrated in FIG. 2B, after performing comparison operations, object recognition module 165 may determine that detected object 134-2 is triggering object 135-1.

FIG. 2C depicts an exemplary data structure capable of storing mapping data associated with triggering objects and their respective applications in accordance with embodiments of the present invention. As illustrated in FIG. 2C, each triggering object (e.g., triggering objects 135-1, 135-2, 135-3, 135-4, etc.) may be mapped to an application (e.g., applications 236-1, 236-2, 236-3, 236-4, etc.) in memory resident on system 100 (e.g., memory locations 150-1, 150-2, 150-3, 150-4, etc.). With further reference to FIG. 2B, object recognition module 165 may scan object data structure 166 and determine that triggering object 135-1 is mapped to application 236-1.

Accordingly, as illustrated in FIG. 2D, application 236-1, depicted as a television remote control application, may be executed in an autonomous manner upon recognition of triggering object 135-1 by object recognition module 165. As such, the user may be able to engage triggering object 135-1 (depicted as a television) in a manner consist with triggering object 135-1's capabilities. For example, the user may be able to use application 236-1 to turn on triggering object 135-1, change triggering object 135-1's channels, adjust triggering object 135-1's volume, etc.

Although a single application is depicted as being executed by system 100 in FIG. 2D, embodiments of the present invention are not limited as such. For instance, in one embodiment, system 100 may be operable to detect multiple triggering objects and execute multiple actions simultaneously in response to their detection (e.g., control several external devices simultaneously). For example, with reference to the embodiment depicted in FIG. 2D, in addition to detecting the triggering object 135-1, system 100 may be configured to simultaneously recognize a DVD triggering object also present in the scene. As such, system 100 may be configured to execute each triggering object's respective application simultaneously (e.g., execute both a television remote control application and a DVD remote control application at the same time). Furthermore, embodiments of the present invention may be configured to execute a configurable joint action between two detected triggering objects in a given scene. For example, in one embodiment, upon detection of both a television triggering object (e.g., triggering object 135-1) and a DVD triggering object, system 100 may be configured to prompt the user to perform a pre-configured joint action using both objects in which system 100 may be configured to turn on both the television triggering object and the DVD triggering object and execute a movie (e.g., the television triggering object may be pre-configured to take the DVD triggering object as a source).

FIG. 2E depicts an exemplary triggering object recognition process in which non-electronic devices are recognized in accordance with embodiments of the present invention. As described herein, triggering objects may also be non-electronic devices captured from scenes external to system 100 using a camera system. For instance, as illustrated in FIG. 2E, triggering objects captured by system using camera system 101 may include objects such as the sky (e.g., scene 134-4). In a manner similar to the various embodiments described herein, object recognition module 165 may compare the image data received from camera system 101 (e.g., image data associated with scene 134-4) to the image data values of recognized triggering objects stored in object data structure 166. Furthermore, as illustrated in FIG. 2E, after performing comparison operations, object recognition module 165 may determine that scene 134-4 is a recognized triggering object and may correspondingly execute application 236-3 (depicted as a weather application) in an autonomous manner.

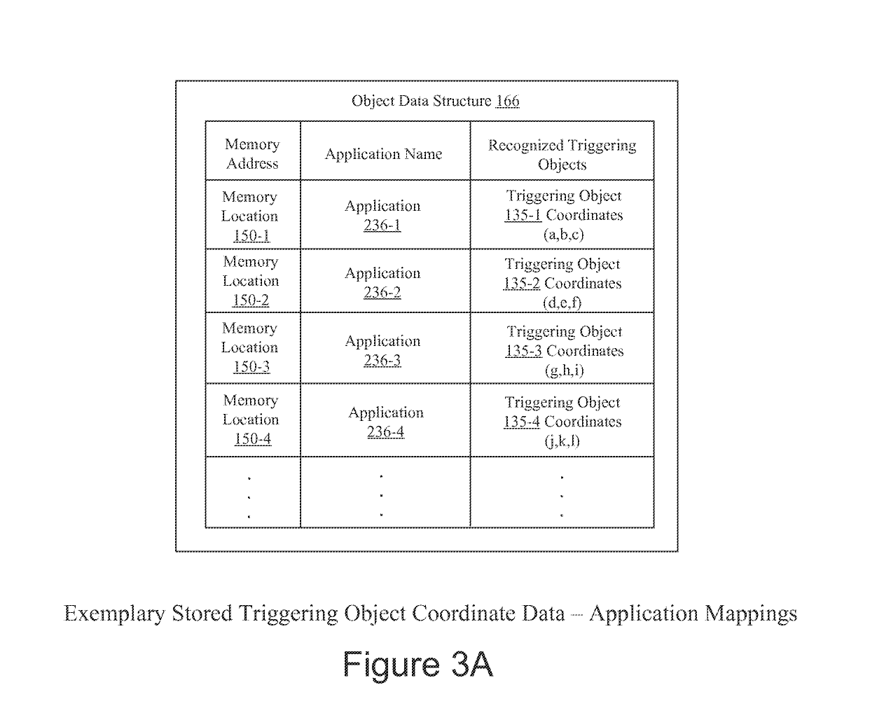

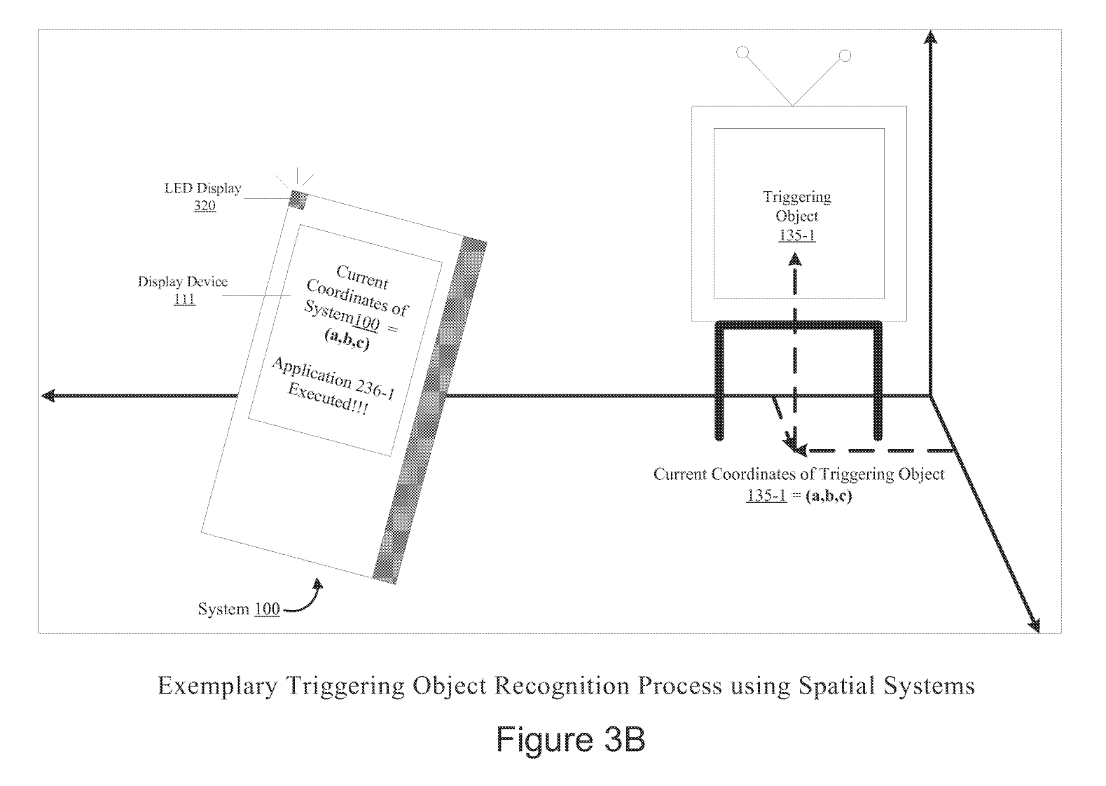

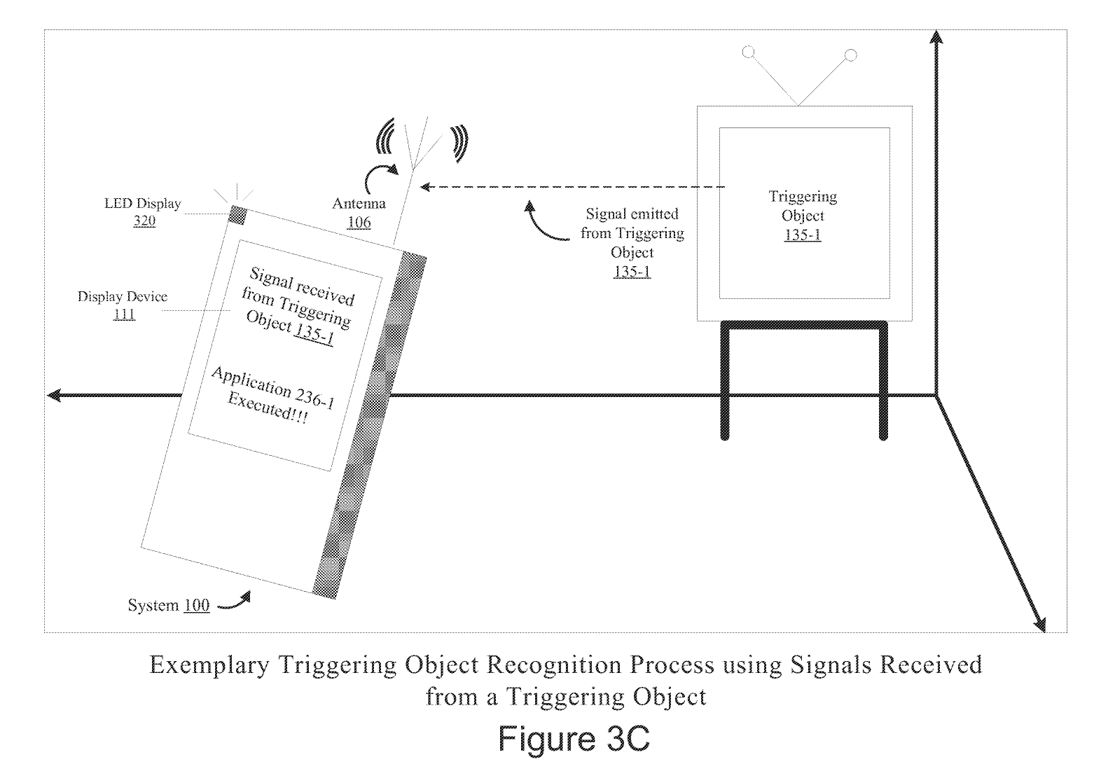

FIG. 3A depicts an exemplary data structure capable of storing coordinate data associated with triggering objects, along with their respective application mappings, in accordance with embodiments of the present invention. As illustrated in FIG. 3A, data stored in object data structure 166 may consist of 3 dimensional coordinate data (e.g., latitude, longitude, elevation) associated with triggering objects recognized by system 100. Furthermore, as illustrated in FIG. 3A, each triggering object may be mapped to an application (applications 236-1, 236-2, 236-3, 236-4, etc.) in memory (e.g., memory locations 150-1, 150-2, 150-3, 150-4, etc.). In this manner, object recognition module 165 may use orientation module 126 and/or GPS module 125 to determine whether a triggering object is within a proximal distance of system 100.

According to one embodiment, a user may provide object recognition module 165 (e.g., via GUI displayed on display device 111) with coordinate data indicating the current location of triggering objects (e.g., coordinate data for triggering objects 135-1, 135-2, 135-3, 135-4) so that system 100 may gauge its position with respect to a particular triggering object at any given time. In this manner, using real-time calculations performed by orientation module 126 and/or GPS module 125 regarding the current position of system 100, object recognition module 165 may be capable of determining whether a particular triggering object (or objects) is within a proximal distance of system 100 and may correspondingly execute an application mapped to that triggering object.

FIG. 3B depicts an exemplary triggering object recognition process using spatial systems in accordance with embodiments of the present invention. As illustrated in FIG. 3B, object recognition module 165 may use real-time calculations performed by orientation module 126 and/or GPS module 125 to determine the current position of system 100. As depicted in FIG. 3B, orientation module 126 and/or GPS module 125 may calculate system 100's current position (e.g., latitude, longitude, elevation) as coordinates (a,b,c). Upon the completion of these calculations, object recognition module 165 may compare the coordinates calculated to coordinate data stored in object data structure 166. As illustrated in FIG. 3B, object recognition module 165 may scan the mapping data stored in object data structure 166 and execute application 236-1, which was linked to triggering object 135-1 (see object data structure 166 of FIG. 3A), after recognizing system 100 being within a proximal distance of triggering object 135-1. According to one embodiment, in a manner similar to the embodiment depicted in FIG. 2A described supra, system 100 may be placed in a surveillance mode in which triggering objects are constantly searched for using orientation module 126 and/or GPS module 125 based on the coordinate data associated with recognized triggering objects stored in object data structure 166. In this manner, according to one embodiment, this surveillance may be performed independent of a camera system (e.g., camera system 101).

FIG. 3C depicts an exemplary triggering object recognition process using signals emitted from a triggering object in accordance with embodiments of the present invention. As illustrated by the embodiment depicted in FIG. 3C, triggering object 135-1 may be a device (e.g., television) capable of emitting signals that may be detected by a receiver (e.g., antenna 106) coupled to system 100. Furthermore, as illustrated in FIG. 3C, object recognition module 165 may compare data received from signals captured via antenna 106 to signal data associated with recognized triggering objects stored in object data structure 166. According to one embodiment, signal data may include positional information, time and/or other information associated with triggering objects. Additionally, in one embodiment, signal data stored in object data structure 166 may include data associated with signal amplitudes, frequencies, or other characteristics capable of distinguishing signals received from multiple triggering objects. Also, according one embodiment, system 100 may notify the user that signals were received from multiple triggering objects and may prompt the user to confirm execution of applications mapped those triggering objects detected.

As illustrated in FIG. 3C, object recognition module 165 may scan the mapping data stored in object data structure 166 and then correspondingly execute application 236-1 after recognizing the signal data received by system 100 as being associated with triggering object 135-1 (see object data structure 166 of FIG. 3A). In one embodiment, system 100 may be capable of converting signals received from triggering objects into a digital signal using known digital signal conversion processing techniques. Furthermore, signals may be transmitted through wired network connections as well as wireless network connections, including, but not limited to, infrared technology, Bluetooth technology, Wi-Fi networks, the Internet, etc.

Although FIGS. 2A through 3C depict various embodiments using different triggering object—application pairings, embodiments of the present invention may not be limited as such. For example, according to one embodiment, applets resident on system 100 may also be configured to execute in response to detection of a triggering object linked to the applet. Also, in one embodiment, system functions and/or processes associated with an operating system running on system 100 may be configured to execute responsive to a detection of a recognized triggering object. Furthermore, applications used to process telephonic events performed on system 100 (e.g., receiving/answering a phone call) may be linked to triggering objects.

FIG. 4 provides a flow chart depicting an exemplary application execution process based on the detection of a recognized triggering object in accordance with embodiments of the present invention.

At step 405, using a data structure resident on a mobile device, applications are mapped to a triggering object in which each mapped application is configured to execute autonomously upon a recognition of its respective triggering object.

At step 410, during a surveillance mode, the mobile device detects objects located external to the mobile device using a camera system.

At step 415, image data gathered by the camera system at step 410 is fed to the object recognition module to determine if any of the objects detected are triggering objects.

At step 420, a determination is made as to whether any of the objects detected during step 410 are triggering objects recognized by the mobile device (e.g., triggering objects mapped to an application in the data structure of step 405). If a detected object is a triggering object recognized by the mobile device, then the object recognition module performs a lookup of mapped applications stored in the data structure to determine which applications are linked to the recognized triggering object determined at step 420, as detailed in step 425. If any of the objects detected are not determined to be a triggering object recognized by the mobile device, then the mobile device continues to operate in the surveillance mode described in step 410.

At step 425, a detected object is a triggering object recognized by the mobile device and, therefore, the object recognition module performs a lookup of mapped applications stored in the data structure to determine which applications are linked to the recognized triggering object determined at step 420.

At step 430, applications determined to be linked to the recognized triggering object determined at step 420 are autonomously executed by the mobile device.

FIG. 5 provides a flow chart depicting an exemplary application execution process based on the detection of multiple recognized triggering objects in accordance with embodiments of the present invention.

At step 505, using a data structure resident on a mobile device, applications are mapped to a triggering object in which each mapped application is configured to execute autonomously upon a recognition of its respective triggering object.

At step 510, during a surveillance mode, the mobile device detects objects located external to the mobile device using a camera system.

At step 515, image data gathered by the camera system at step 510 is fed to the object recognition module to determine if any of the objects detected are triggering objects.

At step 520, a determination is made as to whether any of the objects detected during step 510 are triggering objects recognized by the mobile device (e.g., triggering objects mapped to an application in the data structure of step 505). If at least one detected object is a triggering object recognized by the mobile device, then a determination is made as to whether there are multiple triggering objects recognized during step 520, as detailed in step 525. If any of the objects detected are not determined to be a triggering object recognized by the mobile device, then the mobile device continues to operate in the surveillance mode described in step 510.

At step 525, at least one detected object is a triggering object recognized by the mobile device and, therefore, a determination is made as to whether there are multiple triggering objects recognized during step 520. If multiple triggering objects were recognized during step 520, then the mobile device searches for visual identifiers and/or positional information associated with the objects detected at step 510 to distinguish the recognized triggering objects detected, as detailed in step 530. If multiple objects were not recognized during step 520, then the object recognition module performs a lookup of mapped applications stored in the data structure to determine which applications are linked to a triggering object recognized during step 520, as detailed in step 535.

At step 530, multiple triggering objects were recognized during step 520 and, therefore, the mobile device searches for visual identifiers and/or positional information associated with the objects detected at step 510 to distinguish the recognized triggering objects detected. Furthermore, the object recognition module performs a lookup of mapped applications stored in the data structure to determine which applications are linked to a triggering object recognized during step 520, as detailed in step 535.

At step 535, the object recognition module performs a lookup of mapped applications stored in the data structure to determine which applications are linked to a triggering object recognized during step 520.

At step 540, applications determined to be linked to a triggering object recognized during step 520 are autonomously executed by the mobile device.

FIG. 6 provides a flow chart depicting an exemplary application execution process based on the detection of a recognized triggering object using the GPS module and/or the orientation module in accordance with embodiments of the present invention.

At step 605, using a data structure resident on a mobile device, applications are mapped to a triggering object in which each mapped application is configured to execute autonomously upon a recognition of its respective triggering object.

At step 610, during a surveillance mode, the mobile device detects recognized triggering objects located external to the mobile device using the GPS module and/or the orientation module.

At step 615, data gathered by the GPS module and/or the orientation module at step 610 is fed to the object recognition module.

At step 620, the object recognition module performs a lookup of mapped applications stored in the data structure to determine which applications are linked to the recognized triggering objects detected at step 610.

At step 625, applications determined to be linked to the recognized triggering objects detected at step 610 are autonomously executed by the mobile device.

FIG. 7 provides a flow chart depicting an exemplary system process (e.g., operating system process) executed based on the detection of a recognized triggering object in accordance with embodiments of the present invention.

At step 705, using a data structure resident on a mobile device, system processes are mapped to a triggering object in which each mapped system process is configured to execute autonomously upon recognition of its respective triggering object.

At step 710, during a surveillance mode, the mobile device detects objects located external to the mobile device using a camera system.

At step 715, image data gathered by the camera system at step 710 is fed to the object recognition module to determine if any of the objects detected are triggering objects.

At step 720, a determination is made as to whether any of the objects detected during step 710 are triggering objects recognized by the mobile device (e.g., triggering objects mapped to a system process in the data structure of step 705). If a detected object is a triggering object recognized by the mobile device, then the object recognition module performs a lookup of mapped system processes stored in the data structure to determine which processes are linked to the recognized triggering object detected at step 720, as detailed in step 725. If any of the objects detected are not determined to be a triggering object recognized by the mobile device, then the mobile device continues to operate in the surveillance mode described in step 710.

At step 725, a detected object is a triggering object recognized by the mobile device and, therefore, the object recognition module performs a lookup of mapped system processes stored in the data structure to determine which processes are linked to the recognized triggering object detected at step 720.

At step 730, system processes determined to be linked to the recognized triggering object detected at step 720 are autonomously executed by the mobile device.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above disclosure. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method of executing an application using a computing device, said method comprising:
associating a first application with a first object located external to said computing device;
detecting said first object within a proximal distance of said computing device using a camera system; and
automatically executing said first application upon detection of said first object, wherein said first application is configured to execute upon determining a valid association between said first object and said first application and detection of said first object.

2. The method as described in claim 1, wherein said valid association is a mapped relationship between said first application and said first object, wherein said mapped relationship is stored in a data structure resident on said computing device.

3. The method as described in claim 1, wherein said detecting further comprises detecting said first object using a set of coordinates associated with said first object.

4. The method as described in claim 1, wherein said detecting further comprises detecting said first object using signals emitted from said first object.

5. The method as described in claim 1, wherein said detecting further comprises configuring said computing device to detect said first object during a surveillance mode, wherein said surveillance mode is engaged by a user using a button located on said computing device.

6. The method as described in claim 1, wherein said associating further comprises training said computing device to recognize said first object using said camera system.

7. The method as described in claim 1, further comprising:
associating a second application with a second object located external to said computing device;
detecting said second object within a proximal distance of said computing device using a camera system; and
automatically executing said second application upon detection of said second object, wherein said second application is configured to execute upon determining a valid association between said second object and said second application and detection of said second object.

8. A system for executing an application using a computing device, said system comprising:
an association module operable to associate said application with an object located external to said computing device;
a detection module operable to detect said object within a proximal distance of said computing device using a camera system; and
an execution module operable to execute said application upon detection of said object, wherein said execution module is operable to determine a valid association between said object and said application, wherein said application is configured to automatically execute responsive to said valid association and said detection.

9. The system as described in claim 8, wherein said valid association is a mapped relationship between said application and said object, wherein said mapped relationship is stored in a data structure resident on said computing device.

10. The system as described in claim 8, wherein said detection module is further operable to detect said object using a set of coordinates associated with said object.

11. The system as described in claim 8, wherein said detection module is further operable to detect said object using signals emitted from said object.

12. The system as described in claim 8, wherein said detection module is further operable to detect said object during a surveillance mode, wherein said surveillance mode is engaged by a user using a button located on said computing device.

13. The system as described in claim 8, wherein said associating module is further operable to train said computing device to recognize said object using said camera system.

14. The system as described in claim 8, wherein said associating module is further operable to configure said computing device to recognize said object using machine learning procedures.

15. A method of executing a computer-implemented system process on a computing device, said method comprising:
associating said computer-implemented system process with an object located external to said computing device;
detecting said object within a proximal distance of said computing device using a camera system; and
automatically executing said computer-implemented system process upon detection of said object, wherein said computer-implemented system process is configured to execute upon determining a valid association between said object and said computer-implemented system process and detection of said object.

16. The method as described in claim 15, wherein said valid association is a mapped relationship between said computer-implemented process and said object, wherein said mapped relationship is stored in a data structure resident on said computing device.

17. The method as described in claim 15, wherein said detecting further comprises detecting said object using a set of coordinates associated with said object.

18. The method as described in claim 15, wherein said detecting further comprises detecting said object using signals emitted from said object.

19. The method as described in claim 15, wherein said detecting further comprises configuring said computing device to detect said object during a surveillance mode, wherein said surveillance mode is engaged by a user using a button located on said computing device.

20. The method as described in claim 15, wherein said associating further comprises training said computing device to recognize said object using said camera system.

21. The method as described in claim 15, wherein said associating further comprises configuring said computing device to recognize visual identifiers located on said object responsive to a detection of similar looking objects.
